(19) United States
(12) Patent Application Publication
(10) Pub. No.: US 2009/0034618 A1
(43) Pub. Date: Feb. 5, 2009

(54) DECODING METHOD AND APPARATUS FOR BLOCK-BASED DIGITALLY ENCODED PICTURE

(76) Inventors: Frank Fu, Taipei (TW); Sean Lee, Taipei (TW)

Correspondence Address: SQUIRE, SANDERS & DEMPSEY L.L.P., 1 MARITIME PLAZA, SUITE 300, SAN FRANCISCO, CA, 94111, US

(21) Appl. No.: 11/862,113

(22) Filed: Sep. 26, 2007

(30) Foreign Application Priority Data
Aug. 3, 2007 (TW) 096128732

(51) Int. Cl. H04N 7/12

(52) U.S. Cl. 375/240.16; 375/E07.211

(57) ABSTRACT

A decoding method for block-based digital encoded picture is disclosed. The method including the steps of reconstructing a zeroth reference picture list and a first reference picture list for a current picture based on a predetermined digital picture coding protocol; establishing a lookup table which includes a parameter field for storing a distance scalar, the distance scalar being derived from the time sequence characteristic values of the current picture, the co-located picture and a predetermined reference picture; determining a derived motion vector of a direct mode bi-predictive block according to the distance scalar and a predetermined motion vector of a co-located block with respect to the predetermined reference picture. An apparatus for implementing the method is also disclosed.

### BACKGROUND OF THE INVENTION

1. Field of the Invention

The present invention relates to the digital picture decoding technology, and more particularly to a method and apparatus for decoding blocked-based digitally encoded pictures including direct mode bi-predictive blocks.

2. Description of the Prior Art

A block-based digital image encoding technology typically divides an image frame into many macroblocks (MBs) which are then encoded according to the luminance and chroma data of pixels (picture elements) thereof. For example, in the H.264 coding standard, a macroblock represents an image area containing 16×16 pixels. A macroblock can be encoded in Intra Prediction mode or Inter prediction mode. Intra Prediction is formed based on previously encoded and reconstructed blocks in the same video frame, while Inter Prediction creates a prediction model from one or more previously encoded video frames. Usually, a macroblock tends to be encoded in Inter prediction mode when it is correlated with content of another video frame(s).

Among available Inter prediction encoding techniques, motion compensation doubtless plays an important role. The motion compensation technology creates motion compensation blocks based on previously encoded picture(s), and represents the displacement or shift relative to block(s) of the previously encoded pictures with motion vector(s). The picture used to predict or create the motion compensation block is usually referred to as the reference picture. In the encoding technology such as H.264, the motion vector accuracy can be down to quarter pixel level.

In an encoding technology such as H.264, the motion compensation block mentioned above can be areas with block sizes of 16×16, 8×16, 16×8 or 8×8 pixels in a macroblock. These areas are called partitions. For example, if a macroblock is divided into four 8×8 areas, then the macroblock will include four divided areas. When the partition is the 8×8 mode, it can be further divided into areas with block sizes of 8×8, 4×8, 8×4, or 4×4 pixels. These areas are called sub-partitions. The motion compensation block may also be a sub-partition. Such mechanism in which a macroblock may be further partitioned into motion compensation blocks of variant sizes is known as the tree structured motion compensation. Every motion compensation block may be encoded with one or two motion vectors. When a motion compensation block is encoded with two motion vectors, these two motion vectors can reference the same or different reference pictures. In the encoding technology of using a partition or a sub-partition as a motion compensation prediction unit, such as H.264, the blocks located in the same partition (or sub-partition) will lie in the same motion compensation block and contain the same motion vector(s).

In the typical encoding technology, the bi-predictive block is an important Inter Prediction block, and may be encoded with motion vectors respectively referencing two different reference pictures. The typical encoding standard, such as the H.264, includes a compression mode generally referred to as the direct mode, in which motion vectors are, instead stored in the encoding bit stream, derived from time sequence characteristic values (for example, Picture Order Count or POC) of related pictures and motion vectors of predetermined blocks with respect to predetermined reference pictures. Because no motion vector is included in the encoding data, the compression rate would be better for the pictures or blocks suitable for being encoded in direct mode.

The aforementioned related pictures include the current picture (the picture containing the current block which is the block being currently processed or decoded), the co-located picture of the current picture, as well as the specific reference picture of the co-located block. The co-located picture is the picture referenced by all the direct mode bi-predictive blocks (or referred to as the B_Direct blocks) in the current picture, while the co-located block is the block lying in the co-located picture and having the same coordinate (i.e. location within a picture) as the current block.

Referencing to FIG. 1, which illustrates the relationship among the related pictures and the associated data structure in the direct mode. As shown in FIG. 1, the current picture CurPic includes a current block CurBlk which is a direct mode bi-predictive block, and the co-located picture ColPic includes a co-located block ColBlk as defined above. Note that the co-located block ColBlk is not necessarily a direct mode block or a bi-predictive block. The co-located block ColBlk may be even not an Inter Prediction block (i.e., encoded without any motion vector). The present application, however, considers only the cases in which the co-located block is encoded with motion vector(s). Also shown in FIG. 1 is a mapped picture MapPic, which is a predetermined reference picture referenced by a motion vector of the co-located block ColBlk.

When decoding the current picture CurPic, it needs the reference picture information of all direct mode blocks in the current picture CurPic. Such reference picture information could be saved in a predetermined zone for decoded pictures, such as the frame buffer or other areas in memory. The reference picture information may include decoded data of reference pictures, such as the decoded pixel values, picture order counts (POCs) and motion vectors. The reference picture information could be accessed through reference picture access information. The access information is the address information for accessing predetermined data. For example, the access information could be, but not restricted to, indices or pointers associated with predetermined data storage areas. For example, the access information for all possible reference pictures of all the direct mode blocks in the current picture CurPic may be saved in the zeroth reference picture list L0 and first reference picture list L1 shown in FIG. 1. The most important one is the entry with index zero in the first reference list L1, which stores the access information ColPicRef for the co-located picture ColPic. In other words, the decoded data of the co-located picture ColPic could be obtained through the first reference picture list L1. The access information MapPicRef for the mapped picture MapPic could be obtained through the zeroth reference picture list L0. The information MapPicRef, however, may lie in any entry in the zeroth reference picture list L0. There are respectively 32 entries in the zeroth reference picture list L0 and the first reference picture list L1 shown in FIG. 1. Moreover, the dotted line mvCol in FIG. 1 represents a motion vector of the co-located block ColBlk with respect to the mapped picture MapPic.

FIG. 2 shows associated elements for deriving the motion vectors of the direct mode bi-predictive block CurBlk, in which mvL0 and mvL1 are motion vectors to be derived for the current block CurBlk, mvCol is the motion vector of the co-located block ColBlk with respect to the mapped picture MapPic, tb is the picture order distance between the current picture CurPic and the mapped picture MapPic, and td is the picture order distance between the co-located picture ColPic and the mapped picture MapPic. Both tb and td may be derived from the picture order counts of related pictures. Motion vectors mvL0 and mvL1 could be derived from mvCol, tb and td as below, for example of H.264 protocol:

tx=tb*(16384+abs(td/2))/td (1.a)

mvL0=mvCol*tx (1.b)

mvL1=mvL0−mvCol (1.c)

in which tx is known as the distance scalar which is a parameter derived from tb and td, and abs( ) is the function to obtain the absolute value. Furthermore, in MPEG4 protocol, mvL0 and mvL1 could be derived from following formulas:

tx=tb/td (2.a)

mvL0=mvCol*tx (2.b)

mvL1=mvL0−mvCol (2.c)

The decoding of the direct mode bi-predictive block CurBlk is to obtain the motion vectors mvL0, mvL1 and the associated reference pictures (the co-located picture ColPic and the mapped picture MapPic) as shown in FIG. 1 and FIG. 2. As can be noted from above description of FIG. 2, it is necessary to get the picture ordering counts of the current picture CurPic, the co-located picture ColPic and the mapped picture MapPic so as to compute the distance scalar tx and the picture ordering distances tb and td, such that the motion vectors mvL0 and mvL1 can be derived. During the deriving process of mvL0 and mvL1, in the decoding session of each direct mode block CurBlk, it would take a lot of time to search the zeroth reference picture list L0 for the mapped picture MapPic. In addition, from above formulas, it is necessary to use division to obtain the distance scalar tx, and it would consume a lot of resources to calculate that for each direct mode block CurBlk.

In view of foregoing drawbacks of prior art, there is a need to provide an improvement in the efficiency of obtaining the motion vectors of a direct mode bi-predictive block such that the overall decoding performance can also be improved.

### SUMMARY OF THE INVENTION

The present invention provides an improved decoding method for block-based digitally encoded pictures, which would improve the efficiency to obtain the motion vectors of a direct mode bi-predictive block, and thus increase the decoding performance.

The present invention also provides an apparatus to implement the improved decoding method for block-based digitally encoded pictures.

It is an aspect of the present invention to avoid redundant searching and time-consuming calculation by taking advantage of a pre-constructed lookup table, so as to improve the decoding efficiency of direct mode bi-predictive blocks.

The present invention provides a decoding method for block-based digitally encoded pictures, the method including the steps of: reconstructing a zeroth reference picture list and a first reference picture list for a current picture according to a digital picture encoding protocol, the current picture comprising a direct mode bi-predictive block, and the zeroth reference picture list and the first reference picture list storing access information for decoded pictures during decoding the current picture; obtaining access information for the co-located picture of the current picture through the first reference picture list, the co-located picture comprising a co-located block of the direct mode bi-predictive block, and the co-located block having the same coordinate as that of the direct mode bi-predictive block; obtaining a predetermined index through the access information for the co-located picture, and acquiring the access information of a predetermined reference picture of the co-located block through the predetermined index; determining a reference index by searching the zeroth reference picture list, the reference index being an index of an entry storing the access information of the predetermined reference picture in the zeroth reference picture list; saving the reference index into an index field of an entry indexed by the predetermined index in a first data structure; and determining a derived motion vector of the direct mode bi-predictive block according to a time sequence characteristic value of the current picture, the time sequence characteristic value of the co-located picture, the time sequence characteristic value of the predetermined reference picture and a predetermined motion vector of the co-located block with respect to the predetermined reference picture.

The present invention also includes a decoding apparatus for block-based digitally encoded pictures, the apparatus including a reference picture list reconstruction unit, a lookup table construction unit and a motion vector deriving unit. The reference picture list reconstruction unit is configured to reconstruct a zeroth reference picture list and a first reference picture list for a current picture according to a digital picture encoding protocol, the current picture comprising a direct mode bi-predictive block, and the zeroth reference picture list and the first reference picture list storing access information for decoded pictures during decoding the current picture. The lookup table construction unit is configured to establish a lookup table which comprises an entry containing an index field for storing a reference index associated with the zeroth reference picture list. The motion vector deriving unit is configured to acquire an access information of a predetermined reference picture of a co-located block, and to determine a derived motion vector of the direct mode bi-predictive block according to a time sequence characteristic value of the co-located picture containing the co-located block, the time sequence characteristic value of the predetermined reference picture and a predetermined motion vector of the co-located block with respect to the predetermined reference picture.

### BRIEF DESCRIPTION OF THE DRAWINGS

FIG. 1 illustrates the relationship among the related pictures and the associated data structure in the direct mode.

FIG. 2 shows associated elements for deriving the motion vectors of the direct mode bi-predictive block.

FIG. 3A illustrates a decoding method for block-based digitally encoded pictures as well as the associated data structure according to an embodiment of the present invention.

FIG. 3B shows more details of the direct mode block processing procedure in accordance with an embodiment of the present invention.

FIG. 4A illustrates the associated data structure for obtaining the access information for the reference picture of the co-located block through the predetermined index in accordance with an embodiment of the present invention.

FIG. 4B illustrates the associated data structure for obtaining the access information for the reference picture of the co-located block through the predetermined index in accordance with another embodiment of the present invention.

FIG. 5 shows a block diagram of the block-based digitally encoded picture decoding apparatus according to the present invention.

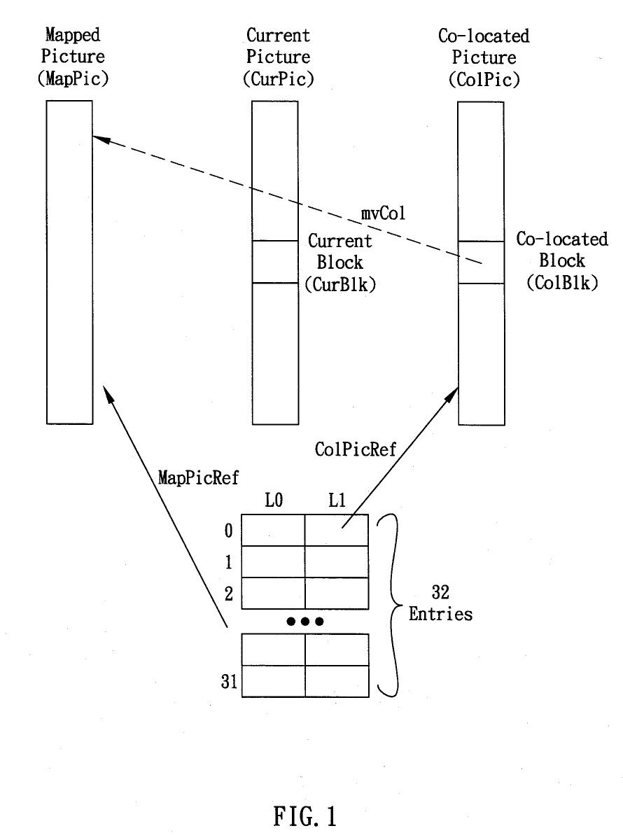

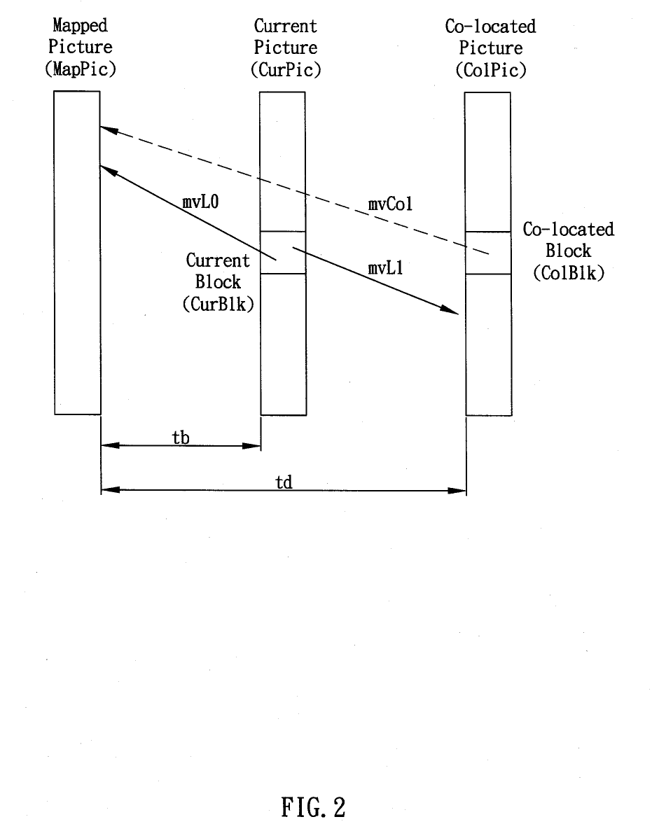

### DETAILED DESCRIPTION OF THE INVENTION

Preferred embodiments in accordance with the present invention will be described below in detail with reference to the accompanying drawings, in which the same reference numerals and letters in the figures designate the same or functionally equivalent parts. In the following description, the access information is the address information used to access predetermined data. For example, the access information may contain, without limitation, an index or a pointer associated with a predetermined data storage area. Besides, the block mentioned below may be an image area containing 8×8 or 16×16 pixels. It should also be understood that only steps or units essential to the present invention will be detailed below. For example, the typical step (or unit) for inputting the bitstream to be decoded from a media source (such as a hard disk, a removable storage unit or even the internet) as well as the step (or unit) for outputting a decoded picture to a display device (such as a liquid crystal display or any other feasible monitor), although not explicitly described below, may be generally part of the disclosed method (or apparatus).

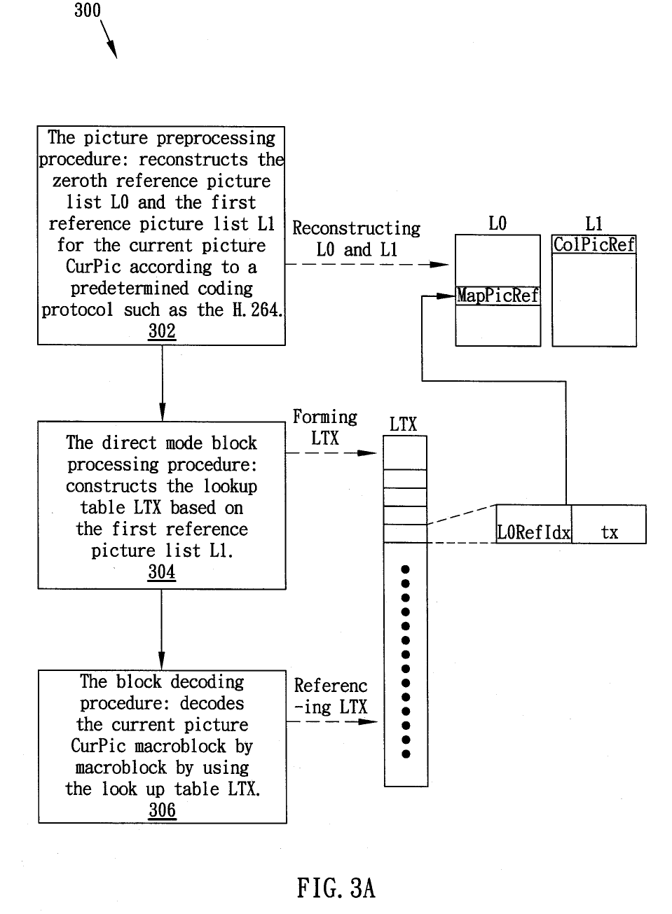

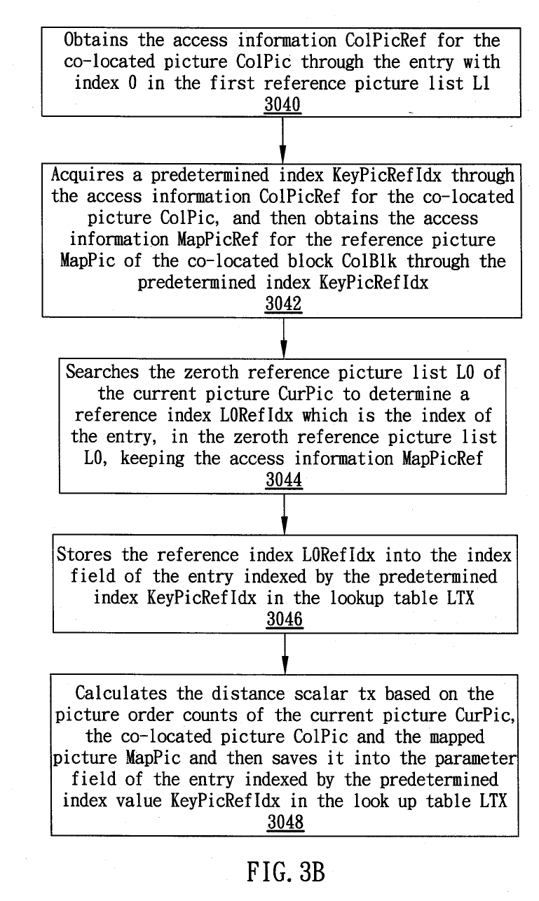

FIG. 3A illustrates a decoding method 300 for block-based digitally encoded pictures as well as the associated data structure according to an embodiment of the present invention. As a decoding procedure for a current picture CurPic, the decoding method 300 includes the picture preprocessing procedure 302, the direct mode block processing procedure 304 and the block decoding procedure 306.

The picture preprocessing procedure 302 reconstructs the zeroth reference picture list L0 and the first reference picture list L1 for the current picture CurPic according to a predetermined coding protocol such as the H.264. As mentioned above, the access information for all possible reference pictures of all the B_Direct blocks in the current picture CurPic may be stored in the zeroth reference picture list L0 and first reference picture list L1. For example, the entry with index value 0 in the first reference picture list L1 keeps the co-located picture access information ColPicRef (i.e., the access information for the co-located picture of the current picture CurPic). Through the co-located picture access information ColPicRef, the decoded data of the co-located picture ColPic may be accessed, such as the aforementioned motion vector mvCol of the co-located block.

The direct mode block processing procedure 304 establishes a lookup table LTX, or other equivalent data structure, based on a specific index value. Each entry of the lookup table LTX may include an index field and/or a parameter field, the index field keeping the reference index L0Refldx associated with the zeroth reference picture list L0, and the parameter field keeping the distance scalar tx. The reference index L0Refldx is the index of the entry (in the zeroth reference picture list L0) keeping the access information for the mapped picture MapPic. The mapped picture MapPic is the reference picture referenced by the predetermined motion vector mvCol of the co-located block ColBlk. As already mentioned above, the co-located block is the block lying in the co-located picture and having the same coordinate (i.e. location within a picture) as the current block.

The direct mode block processing procedure 304 constructs the lookup table LTX based on the first reference picture list L1. The details will now be described with reference to related figures.

FIG. 3B shows more details of the direct mode block processing procedure 304 in accordance with an embodiment of the present invention. Step 3040 obtains the access information ColPicRef for the co-located picture ColPic of current picture CurPic through the entry with index 0 in the first reference picture list L1. The co-located picture ColPic contains the co-located block ColBlk of the direct mode bi-predictive block CurBlk. As mentioned above, the co-located block ColBlk is the block, in the co-located picture ColPic, having the same coordinate as that of the direct mode bi-predictive block CurBlk.

Step 3042 acquires a predetermined index KeyPicRefldx through the access information ColPicRef for the co-located picture ColPic, and then obtains the access information MapPicRef for the reference picture MapPic (i.e., the mapped picture or the reference picture referenced by the motion vector mvCol) of the co-located block ColBlk through the predetermined index KeyPicRefldx. The reference picture data of the co-located block ColBlk could be stored in the system memory in various ways. It is covered by the spirit of the present invention as long as the data of the mapped picture MapPic can be obtained through the predetermined index value KeyPicRefldx directly or indirectly.

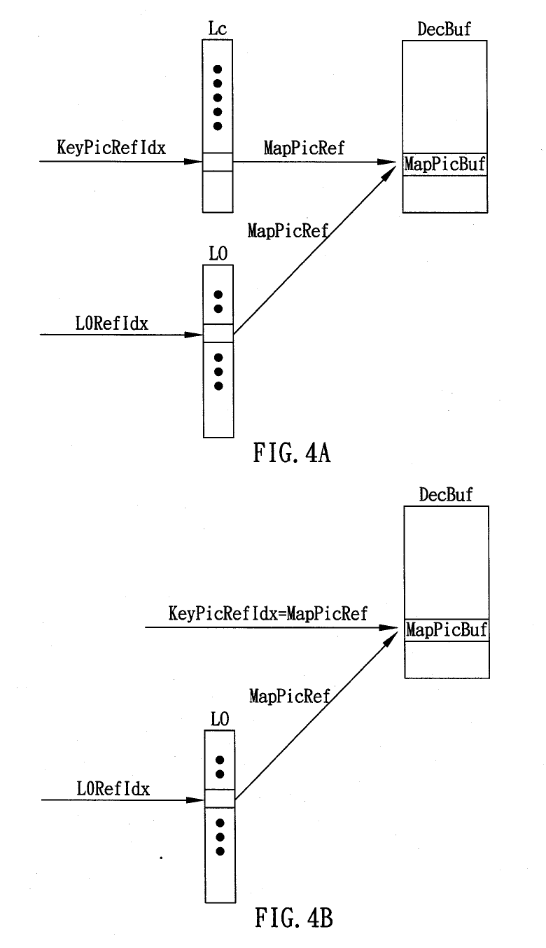

Referring to FIG. 4A, which illustrates the associated data structure for obtaining the access information MapPicRef for the reference picture MapPic of the co-located block ColBlk through the predetermined index KeyPicRefldx in accordance with an embodiment of the present invention. In this embodiment, the predetermined index KeyPicRefldx is an index associated with a reference picture list Lc (which may be the zeroth reference picture list L0c or the first reference picture list L1c of the co-located picture ColPic according to, for example, the H.264 encoding protocol) of the co-located picture ColPic. Furthermore, the predetermined index KeyPicRefldx is the index of the entry, in the reference picture list Lc, keeping the access information MapPicRef for the reference picture. The decoded data (for example, the picture order counts, and the decoded pixel values) of the mapped picture MapPic could be accessed through the access information MapPicRef. In FIG. 4A, the decoded data of the mapped picture MapPic is stored in the mapped picture buffer MapPicBuf. The mapped picture buffer MapPicBuf is located in the decoded picture storage area DefBuf such as the frame buffer.

According to another embodiment of the present invention, the picture order counts and the decoded pixel values may be respectively stored in different buffers. Such modification is covered in the scope of the present invention as long as all decoded data of the mapped pictures MapPic can be obtained through the access information MapPicRef.

FIG. 4B illustrates the associated data structure for obtaining the access information MapPicRef for the reference picture MapPic of the co-located block ColBlk through the predetermined index KeyPicRefldx in accordance with another embodiment of the present invention. In this embodiment, the predetermined index KeyPicRefldx is itself the access information MapPicRef. In other words, the predetermined index KeyPicRefldx may directly access the decoded data of the mapped picture MapPic.

In both cases illustrated in FIG. 4A and 4B, the predetermined index KeyPicRefldx is known when the decoding of the co-located picture ColPic is completed. In other words, the predetermined index KeyPicRefldx is part of the decoded data of the co-located picture ColPic, which accordingly may be obtained through the access information ColPicRef for the co-located picture ColPic.

Returning to FIG. 3B and collectively referring to FIG. 4A or FIG. 4B for the following description. Step 3044 searches the zeroth reference picture list L0 of the current picture CurPic to determine a reference index L0Refldx. As shown in FIG. 4A or FIG. 4B, the reference index L0Refldx is the index of the entry, in the zeroth reference picture list L0, keeping the access information MapPicRef.

Step 3046 stores the reference index L0Refldx into the index field of the entry indexed by the predetermined index KeyPicRefldx in the lookup table LTX. Step 3048 calculates the distance scalar tx (for example, by using the formula 1.a or 2.a) based on the picture order counts of the current picture CurPic, the co-located picture ColPic and the mapped picture MapPic and then saves it into the parameter field of the entry indexed by the predetermined index value KeyPicRefldx in the look up table LTX.

It can be noted from above description that steps 3040 through 3046 aim to construct the lookup table LTX. A complete lookup table LTX may be established by repeating steps 3040 through 3046 for each block of the current picture CurPic.

The block decoding procedure 306 may decode the current picture CurPic, for example, macroblock by macroblock. By using the look up table LTX, the decoding of all the direct mode bi-predictive blocks in current picture CurPic would be more efficient. Because the distance scalars of direct mode motion vectors mvL0 and mvL1 may be obtained by a table looking-up manner through the parameter field in the look up table LTX, the entire decoding performance is thus improved. The reference index L0Refldx, of the zeroth reference picture list L0, stored in the index field could be output to and used by other modules in the decoder. Specifically, the block decoding procedure 306 would determine a derived motion vector of the direct mode bi-predictive block CurBlk, according to the distance scalar tx stored in the parameter field of the look table LTX and a predetermined motion vector mvCol of the co-located block ColBlk with respect to the mapped picture MapPic (for example, by the formula 1.b or 2.b).

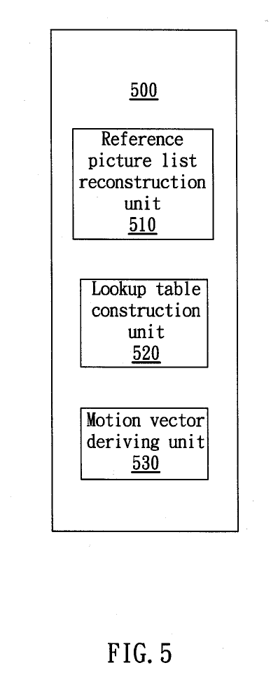

According to another embodiment of the present invention, there may be no parameter field for keeping the distance scalar tx in the look up table LTX established in the direct mode block processing procedure 304. Through the picture order count of the current picture CurPic, the picture order count of the co-located picture ColPic, the picture order count of the predetermined reference picture MapPic and the predetermined motion vector mvCol of the co-located block ColBlk with respect to the predetermined reference picture MapPic, the block decoding procedure 306 may still determine the derived motion vector of the direct mode bi-predictive block CurBlk. The present invention also includes an apparatus for implementing the foregoing decoding method for block-based digitally encoded picture. FIG. 5 shows a block diagram of the block-based digitally encoded picture decoding apparatus 500 according to the present invention, which includes a reference picture list reconstruction unit 510, a lookup table construction unit 520 and a motion vector deriving unit 530. The reference picture list reconstruction unit 510 may perform the picture preprocessing procedure 302 mentioned above, i.e., the reference picture list reconstruction unit 510 may reconstruct the zeroth reference picture list L0 and the first reference picture list L1 for the current picture CurPic according to a digital picture encoding protocol such as H.264. The lookup table construction unit 520 may perform the procedure establishing lookup table LTX as disclosed in steps 3040 through 3046, in which the lookup table LTX may include an index field. As can be noted from steps 3040 through 3046, the index field may keep the reference index L0Refldx associated with the zeroth reference picture list L0. The motion vector deriving unit 530 may perform the block decoding procedure 306. For example, it may determine a derived motion vector of the direct mode bi-predictive block CurBlk according to the distance scalar tx stored in the parameter field of the lookup table LTX and the predetermined motion vector mvCol of the co-located block ColBlk with respect to the predetermined reference picture MapPic. In general, units 510-530 exemplified in this embodiment may be implemented as software modules in a microprocessor or digital signal processor based structure or as logic elements in an application specific integration circuit (ASIC). From the disclosure of the present invention, those skilled in the art should be readily able to design the software codes or logic elements corresponding to the units described in this embodiment.

It should be understood, however, that there is no intention to limit the invention to the specific forms disclosed. The invention is to cover all modifications, alternate constructions and equivalents falling within the spirit and scope of the invention as expressed in the appended claims.

What is claimed is:

1. A decoding method for block-based digitally encoded pictures, comprising:
reconstructing a zeroth reference picture list and a first reference picture list for a current picture according to a digital picture encoding protocol, the current picture comprising a direct mode bi-predictive block, and the zeroth reference picture list and the first reference picture list storing access information for decoded pictures during decoding the current picture;
obtaining access information for the co-located picture of the current picture through the first reference picture list, the co-located picture comprising a co-located block of the direct mode bi-predictive block, and the co-located block having the same coordinate as that of the direct mode bi-predictive block;
obtaining a predetermined index through the access information for the co-located picture, and acquiring the access information of a predetermined reference picture of the co-located block through the predetermined index;
determining a reference index by searching the zeroth reference picture list, the reference index being an index of an entry storing the access information of the predetermined reference picture in the zeroth reference picture list;
saving the reference index into an index field of an entry indexed by the predetermined index in a first data structure; and
determining a derived motion vector of the direct mode bi-predictive block according to a time sequence characteristic value of the current picture, the time sequence characteristic value of the co-located picture, the time sequence characteristic value of the predetermined reference picture and a predetermined motion vector of the co-located block with respect to the predetermined reference picture.

2. The decoding method as claimed in claim 1, wherein the first data structure is a look up table which further includes a parameter field for storing a distance scalar, the distance scalar being derived from the time sequence characteristic value of the current picture, the time sequence characteristic value of the co-located picture and the time sequence characteristic value of the predetermined reference picture.

3. The decoding method as claimed in claim 2, wherein the derived motion vector is calculated by multiplying the predetermined motion vector by the distance scalar.

4. The decoding method as claimed in claim 1, wherein the access information of the predetermined reference picture is acquired from an entry indexed by the predetermined index in a second data structure.

5. The decoding method as claimed in claim 4, wherein the second data structure is a second reference picture list for storing the access information of decoded pictures during decoding the co-located picture.

6. The decoding method as claimed in claim 1, wherein the access information comprises an index associated with a decoded picture storage area.

7. The decoding method as claimed in claim 1, wherein the direct mode bi-predictive block is an 8×8 pixel block.

8. The decoding method as claimed in claim 1, wherein the time sequence characteristic value is Picture Order Count (POC).

9. The decoding method as claimed in claim 1, wherein the digital picture encoding protocol is H.264.

10. A decoding method for block-based digitally encoded pictures, comprising:
reconstructing a zeroth reference picture list and a first reference picture list for a current picture according to a digital picture encoding protocol, the current picture comprising a direct mode bi-predictive block, and the zeroth reference picture list and the first reference picture list storing access information for decoded pictures during decoding the current picture;
establishing a look up table which comprises an entry containing a parameter field for storing a distance scalar, the distance scalar being derived from a time sequence characteristic value of the current picture, the time sequence characteristic value of a co-located picture and the time sequence characteristic value of a predetermined reference picture of a co-located block;
determining a derived motion vector of the direct mode bi-predictive block according to the parameter field and a predetermined motion vector of the co-located block with respect to the predetermined reference picture,
wherein the access information of the co-located picture is in the first reference picture list, and the co-located block is a block in the co-located picture and has the same coordinate with the direct mode bi-predictive block.

11. The decoding method as claimed in claim 10, wherein the entry of the lookup table further comprises an index field for storing a reference index associated with the zeroth reference picture list, the reference index being an index of an entry storing the access information of the predetermined reference picture in the zeroth reference picture list.

12. The decoding method as claimed in claim 10, wherein the derived motion vector is calculated by multiplying the predetermined motion vector by the distance scalar.

13. The decoding method as claimed in claim 10, wherein the access information of the predetermined reference picture is acquired from an entry indexed by a predetermined index in a predetermined data structure.

14. The decoding method for block-based digital encoded picture as claimed in claim 13, wherein the predetermined data structure is a second reference picture list for storing the access information of decoded pictures during decoding the co-located picture.

15. The decoding method for block-based digital encoded picture as claimed in claim 10, wherein the access information comprises an index associated with a decoded picture storage area.

16. A decoding apparatus for block-based digitally encoded pictures, comprising:
a reference picture list reconstruction unit, configured for reconstructing a zeroth reference picture list and a first reference picture list for a current picture according to a digital picture encoding protocol, the current picture comprising a direct mode bi-predictive block, and the zeroth reference picture list and the first reference picture list storing access information for decoded pictures during decoding the current picture;
a lookup table construction unit, configured for establishing a lookup table which comprises an entry containing an index field for storing a reference index associated with the zeroth reference picture list; and
a motion vector deriving unit, configured for acquiring an access information of a predetermined reference picture of a co-located block, and determining a derived motion vector of the direct mode bi-predictive block according to a time sequence characteristic value of the co-located picture containing the co-located block, the time sequence characteristic value of the predetermined reference picture and a predetermined motion vector of the co-located block with respect to the predetermined reference picture,
wherein the access information of the co-located picture is in the first reference picture list, and the co-located block has the same coordinate with the direct mode bi-predictive block in the co-located picture.

17. The decoding apparatus as claimed in claim 16, wherein the entry of the look up table further comprises a parameter field for storing a distance scalar derived from the time sequence characteristic value of the current picture, the time sequence characteristic value of the co-located picture and the time sequence characteristic value of the predetermined reference picture.

18. The decoding apparatus as claimed in claim 17, wherein the derived motion vector equals the predetermined motion vector multiplied by the distance scalar.

19. The decoding apparatus as claimed in claim 16, wherein the access information of the predetermined reference picture is acquired from an entry indexed by a predetermined index in a predetermined data structure.

20. The decoding apparatus as claimed in claim 19, wherein the predetermined data structure is a second reference picture list for storing the access information of decoded pictures during decoding the co-located picture.
